(19) United States
(12) Patent Application Publication
(10) Pub. No.: US 2018/0224023 A1
(43) Pub. Date: Aug. 9, 2018

(54) UNIDIRECTIONAL FLOW CONTROL VALVE

(71) Applicant: KYB Corporation, Tokyo (JP)

(72) Inventor: Toru TAKEUCHI, Kanagawa (JP)

(73) Assignee: KYB Corporation, Tokyo (JP)

(21) Appl. No.: 15/750,914

(22) PCT Filed: Aug. 12, 2016
(86) PCT No.: PCT/JP2016/073775

§ 371 Date: Feb. 7, 2018

(30) Foreign Application Priority Data
Sep. 7, 2015 (JP) 2015-175880

(51) Int. Cl. F16K 31/42; F16K 31/06

(52) U.S. Cl. CPC F16K 31/42; F16K 31/0644

(57) ABSTRACT

The present invention prevents opening of a unidirectional flow control valve caused by an increase in the pressure in a sub port. A solenoid valve controls a flow rate of working oil flowing from a main port to a sub port, and includes: a main valve that enables communication between the main port and the sub port; a control pressure chamber that biases the main valve in a direction of closing the main valve; a first valve body provided in a main port communication passage that enables communication between the main port and the control pressure chamber; and a second valve body provided in a sub port communication passage that enables communication between the sub port and the control pressure chamber.

### TECHNICAL FIELD

The present invention relates to a unidirectional flow control valve.

### BACKGROUND ART

Hydraulically operated construction machines and industrial machines use a unidirectional flow control valve that controls a flow rate of working oil in accordance with an electromagnetic force.

JP 2007-239996A describes a unidirectional flow control valve including a main valve that changes an opening degree for communication between a main port and a sub port, and a control pressure chamber that biases the main valve in a direction of closing the main valve. This unidirectional flow control valve controls a flow rate of a working fluid supplied from a pump connected to the main port to an actuator of a construction machine and the like connected to the sub port.

### SUMMARY OF INVENTION

With the unidirectional flow control valve disclosed in JP 2007-239996A, the pressure in the sub port that communicates with the actuator acts in a direction of opening the main valve when the main valve is closed. Therefore, after the supply of the working fluid to the actuator is stopped, if the pressure inside the actuator increases due to, for example, an increase in an external load acting on the actuator, the pressure in the sub port also increases. This could possibly open the main valve. Once the main valve has been opened, the working fluid outflows from the sub port to the main port, making it difficult to retain the load on the actuator.

The present invention aims to prevent opening of a unidirectional flow control valve caused by an increase in the pressure in a sub port.

According to one aspect of the present invention, a unidirectional flow control valve capable of controlling a flow rate of a working fluid flowing from a main port to a sub port is provided. The unidirectional flow control valve includes: a main valve configured to enable communication between the main port and the sub port; a control pressure chamber configured to bias the main valve in a direction of closing the main valve; a main port communication passage configured to enable communication between the main port and the control pressure chamber; a sub port communication passage configured to enable communication between the sub port and the control pressure chamber; a first valve body provided in the main port communication passage, the first valve body being configured to permit only a flow of the working fluid from the main port to the control pressure chamber; a second valve body provided in the sub port communication passage, the second valve body being configured to permit only a flow of the working fluid from the sub port to the control pressure chamber; and a solenoid unit configured to control an opening degree for communication between the control pressure chamber and the sub port.

### BRIEF DESCRIPTION OF DRAWINGS

FIG. 1 is a cross-sectional view of a solenoid valve according to a first embodiment of the present invention.

FIG. 2 is an enlarged view of a first valve body and a second valve body shown in FIG. 1.

FIG. 3 is a cross-sectional view of a solenoid valve according to a second embodiment of the present invention.

FIG. 4 is an enlarged view of a release valve shown in FIG. 3.

### DESCRIPTION OF EMBODIMENTS

The following describes embodiments of the present invention with reference to the attached drawings.

### First Embodiment

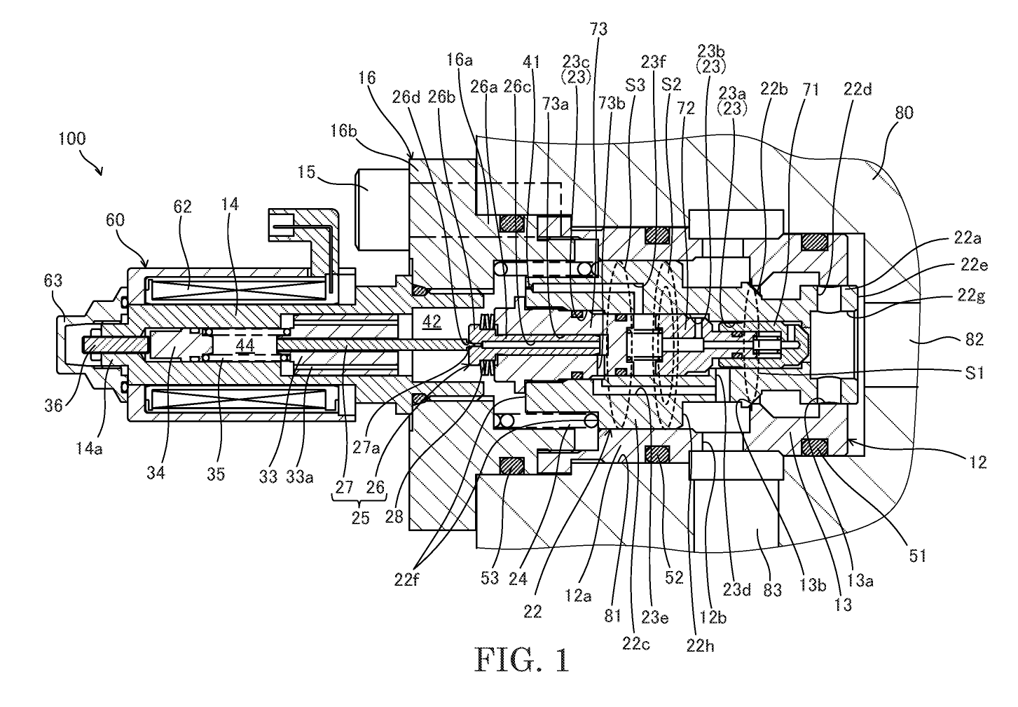

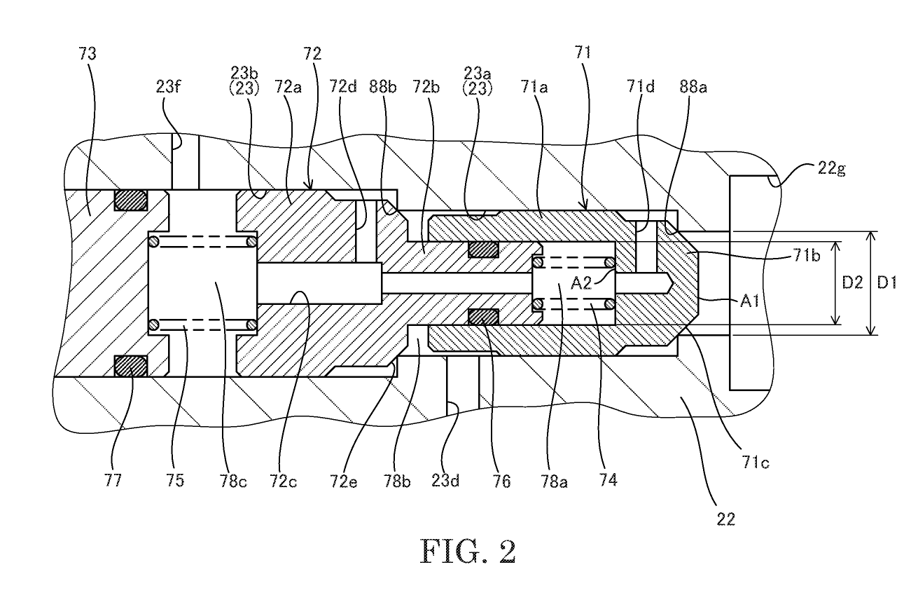

A solenoid valve 100 according to a first embodiment of the present invention will now be described with reference to FIGS. 1 and 2.

The solenoid valve 100, shown in FIG. 1, is provided in construction machines, industrial machines, and so forth to control a flow rate of a working fluid supplied from a non-illustrated fluid pressure source to an actuator (load), and a flow rate of a working fluid discharged from the actuator to, for example, a tank. This solenoid valve 100 is a unidirectional flow control valve that controls a flow rate of a working fluid flowing unidirectionally from a main port 82 to a sub port 83.

The solenoid valve 100 is fixedly inserted in a non-penetrating insertion hole 81 provided in a valve block 80. The valve block 80 has the main port 82 and the sub port 83. One end of the main port 82 opens to a bottom surface of the insertion hole 81. The other end of the main port 82 opens to an outer surface of the valve block 80, and is connected to a pump serving as the fluid pressure source via, for example, a non-illustrated pipe. One end of the sub port 83 opens to a side surface of the insertion hole 81. The other end of the sub port 83 opens to an outer surface of the valve block 80, and is connected to the actuator via, for example, a non-illustrated pipe.

In the solenoid valve 100, working oil is used as the working fluid. The working fluid is not limited to working oil, and may be another incompressible fluid or compressible fluid.

The solenoid valve 100 includes a main valve 22, a hollow cylindrical sleeve 12, a control pressure chamber 42, a first valve body 71, a second valve body 72, a sub valve 27, and a solenoid unit 60. The main valve 22 changes an opening degree for communication between the main port 82 and the sub port 83. The sleeve 12, in which the main valve 22 is slidably inserted, is fixed inside the insertion hole 81. Working oil is directed from the main port 82 or the sub port 83 to the control pressure chamber 42 that biases the main valve 22 in a direction of closing the main valve 22. The first valve body 71 permits only the flow of working oil from the main port 82 to the control pressure chamber 42. The second valve body 72 permits only the flow of working oil from the sub port 83 to the control pressure chamber 42. The sub valve 27 changes an opening degree for communication between the control pressure chamber 42 and the sub port 83. The solenoid unit 60 displaces the sub valve 27 in accordance with supplied current.

The sleeve 12 includes a slide support 12a and a seat 13. An outer circumferential surface of the main valve 22 is slidably supported by the slide support 12a. The seat 13 allows the main valve 22 to be seated thereon.

Two seat portions, namely, a first seat portion 13a that forms a circular hole and a second seat portion 13b that forms a circular truncated cone, are arranged on an inner circumference of the seat 13 in this order, with the first seat portion 13a being closer to the main port 82 than the second seat portion 13b is. A central axis of the first seat portion 13a and a central axis of the second seat portion 13b coincide with a central axis of the sleeve 12.

In the sleeve 12, a plurality of sleeve communication holes 12b that enable communication between a space inside the sleeve 12 and the sub port 83 are provided at circumferential intervals between the second seat portion 13b and the slide support 12a.

An O-ring 51 and an O-ring 52 are mounted on an outer circumference of the seat 13 and an outer circumference of the slide support 12a, respectively, with the sleeve communication holes 12b interposed therebetween. The site of connection between the sleeve communication holes 12b and the sub port 83 is sealed by the two O-rings 51, 52 that are compressed between the sleeve 12 and the insertion hole 81. Especially, the O-ring 51 mounted on the outer circumference of the seat 13 prevents the main port 82 and the sub port 83 from communicating with each other via a gap between the sleeve 12 and the insertion hole 81.

The main valve 22 is a columnar member that is disposed inside the sleeve 12 in such a manner that one end surface 22e is located near the seat 13, and a slide portion 22c is slidably supported by the slide support 12a. The other end surface 22f of the main valve 22 faces the control pressure chamber 42 defined by the main valve 22, the sleeve 12, and the solenoid unit 60.

The main valve 22 has a columnar spool valve 22a that is located near one end surface 22e and slidably inserted in the first seat portion 13a. The main valve 22 also has a poppet valve 22b that is located between the spool valve 22a and the slide portion 22c, can be seated on the second seat portion 13b, and forms a circular truncated cone. The main valve 22 further has a step portion 22h that is located between the poppet valve 22b and the slide portion 22c and has a surface perpendicular to an axial direction of the main valve 22. The pressure in the sub port 83 acts on the step portion 22h via the sleeve communication holes 12b.

A recess 22g that communicates with the main port 82 is provided on one end surface 22e of the main valve 22 so as to be coaxial with the spool valve 22a. A plurality of through holes 22d are provided at circumferential intervals in the spool valve 22a. One end of each through hole 22d opens to a surface that slides on the first seat portion 13a. The other end of each through hole 22d opens to an inner circumferential surface of the recess 22g.

Each through hole 22d, which is closed by the first seat portion 13a, is gradually opened as the spool valve 22a moves in a direction of separating the poppet valve 22b and the second seat portion 13b from each other. That is, an exposed opening area of each through hole 22d is created by separation from the first seat portion 13a, and changes in accordance with an amount of movement of the spool valve 22a. Such a change in the opening area of each through hole 22d enables control of a flow rate of working oil flowing from the main port 82 to the sub port 83.

Each through hole 22d is arranged in such a manner that it is not completely closed by the first seat portion 13a even when the poppet valve 22b is in contact with the second seat portion 13b. That is, the opening area of each through hole 22d has the smallest value at a valve-closing position where the poppet valve 22b is in contact with the second seat portion 13b, and gradually increases as the poppet valve 22b is displaced in a direction of opening the poppet valve 22b.

Each through hole 22d may be arranged in such a manner that it is closed by the first seat portion 13a until the poppet valve 22b moves away from the second seat portion 13b to a certain extent. In this case, a flow rate of working oil can be set to almost zero until the main valve 22 is displaced to a certain extent.

As shown in FIGS. 1 and 2, the main valve 22 has an axially penetrating through hole 23. The through hole 23 is composed of a first slide hole 23a, a second slide hole 23b, and a fixture hole 23c. The first slide hole 23a, in which the first valve body 71 is housed, opens to the recess 22g of the main valve 22. The second slide hole 23b, in which the second valve body 72 is housed, is continuous with the first slide hole 23a. The fixture hole 23c is continuous with the second slide hole 23b, and opens to the other end surface 22f. Central axes of the first slide hole 23a, the second slide hole 23b, and the fixture hole 23c coincide with a central axis of the main valve 22. Therefore, the first slide hole 23a, the second slide hole 23b, and the fixture hole 23c can be processed along with processing of the main valve 22. Furthermore, the precision of concentricity can be improved.

A cylindrical plug 73 is screwed to the fixture hole 23c. The plug 73 closes the second slide hole 23b at one end, and faces the control pressure chamber 42 at the other end. The plug 73 has a sleeve slide hole 73a in which a later-described pressure compensation sleeve 26 is slidably inserted, and a plug communication hole 73b that opens to the sleeve slide hole 73a at one end, and opens to an outer circumference of the plug 73 at the other end. The sleeve slide hole 73a is a non-penetrating hole that has an opening facing the control pressure chamber 42 and extends along a shaft center of the plug 73. A central axis of the sleeve slide hole 73a coincides with the central axis of the main valve 22. That is, the sleeve slide hole 73a is coaxial with the first slide hole 23a, the second slide hole 23b, and the fixture hole 23c provided in the main valve 22.

Two O-rings 77 are mounted on the outer circumference of the plug 73 with an opening of the plug communication hole 73b interposed therebetween. These O-rings 77, which are compressed between the plug 73 and the through hole 23, prevent communication between the plug communication hole 73b and an adjacent oil chamber.

The main valve 22 further has a sub port communication hole 23d, a control pressure chamber communication hole 23f, and a discharge passage 23e. The sub port communication hole 23d opens to the first slide hole 23a at one end, thereby enabling communication between the sub port 83 and a space inside the through hole 23. The control pressure chamber communication hole 23f opens to the second slide hole 23b at one end, thereby enabling communication between the control pressure chamber 42 and the space inside the through hole 23. The discharge passage 23e opens to the fixture hole 23c at one end, thereby enabling communication between the plug communication hole 73b and the sub port communication hole 23d. The control pressure chamber communication hole 23f is provided with a lead-in hole 41 that functions as an orifice.

The first valve body 71 is a cylindrical poppet valve with a bottom, and includes a hollow cylindrical portion 71a slidable along the first slide hole 23a, and an apical portion 71b provided with a first valve portion 71c that can be seated on a first seat portion 88a. The first seat portion 88a is provided in the first slide hole 23a, and forms a circular truncated cone. As the apical portion 71b of the first valve body 71 faces the recess 22g as shown in FIGS. 1 and 2, the pressure in the main port 82 always acts on the apical portion 71b.

The second valve body 72 has a slide portion 72a that is slidable along the second slide hole 23b, a support 72b that extends from the slide portion 72a and is inserted in the hollow cylindrical portion 71a of the first valve body 71, and a second valve body through hole 72c that axially penetrates the second valve body 72. The first valve body 71 is slidably supported by the support 72b of the second valve body 72 in such a manner that the first valve body 71 is displaced along the first slide hole 23a. Thus, the first valve body 71 and the second valve body 72 slide, or are displaced, in the same direction, and are arranged in series along this direction.

The second valve body 72 further has a poppet-like second valve portion 72e that can be seated on a second seat portion 88b. The second seat portion 88b is provided in a step portion that connects the first slide hole 23a and the second slide hole 23b together and forms a circular truncated cone. The first seat portion 88a and the second seat portion 88b may be provided directly in the through hole 23. Alternatively, they may be realized by fixedly inserting a member provided with a seat surface forming a circular truncated cone inside the through hole 23.

A third pressure chamber 78c serving as a pressure chamber is defined between the second valve body 72 and the plug 73. The pressure in the control pressure chamber 42 is directed to the third pressure chamber 78c via the control pressure chamber communication hole 23f. A second spring 75 is installed in a compressed state inside the third pressure chamber 78c. A biasing force of the second spring 75 and the pressure in the third pressure chamber 78c act in a direction of closing the second valve body 72.

The support 72b defines a first pressure chamber 78a inside the hollow cylindrical portion 71a of the first valve body 71. The pressure in the third pressure chamber 78c, that is, the pressure in the control pressure chamber 42, is directed to the first pressure chamber 78a via the second valve body through hole 72c. A first spring 74 is installed in a compressed state inside the first pressure chamber 78a. A biasing force of the first spring 74 and the pressure in the first pressure chamber 78a act in a direction of closing the first valve body 71. Thus, the first spring 74 and the second spring 75 are disposed in such a manner that the directions of their biasing forces both extend along the through hole 23.

It is preferable that a diameter D2 of the first pressure chamber 78a be large so that the first spring 74 is easily housed in the first pressure chamber 78a. However, because the pressure in the control pressure chamber 42 is directed to the first pressure chamber 78a via the second valve body through hole 72c, if the diameter D2 of the first pressure chamber 78a is larger than a diameter D1 of the first seat portion 88a, a force acting in the direction of closing the first valve body 71 will be large, and hence it will be difficult to open the first valve body 71.

For this reason, it is preferable to set the diameter D2 of the first pressure chamber 78a to be smaller than the diameter D1 of the first seat portion 88a. In other words, the diameter D2 of the first pressure chamber 78a is set so that, when the first valve portion 71c is seated on the first seat portion 88a, a first pressure receiving surface A1 of the apical portion 71b that receives the pressure in a direction of opening the first valve body 71 is larger in area than a second pressure receiving surface A2 of the apical portion 71b that receives the pressure in the first pressure chamber 78a.

An annular second pressure chamber 78b is defined between the hollow cylindrical portion 71a of the first valve body 71 and the second valve portion 72e of the second valve body 72. The pressure in the sub port 83 is directed to the second pressure chamber 78b via the sub port communication hole 23d. As shown in FIG. 2, an inner diameter of the second pressure chamber 78b is set to be equal to the diameter D2 of the first pressure chamber 78a, and to be smaller than the diameter D1 of the first seat portion 88a. Therefore, the pressure in the second pressure chamber 78b acts in a direction of opening the second valve body 72, and also acts in the direction of closing the first valve body 71 in resistance to the pressure in the main port 82 acting on the first pressure receiving surface A1.

An O-ring 76 compressed between the support 72b of the second valve body 72 and the hollow cylindrical portion 71a is mounted on an outer circumference of the support 72b. The O-ring 76 prevents the first pressure chamber 78a and the second pressure chamber 78b from communicating with each other via a gap between the support 72b and the hollow cylindrical portion 71a. Backup rings may be disposed adjacent to the O-rings 76, 77 to restrain the O-rings 76, 77 from sticking out.

The first valve body 71 also has a first communication hole 71d that enables communication between the main port 82 and the first pressure chamber 78a when the first valve portion 71c is separated from the first seat portion 88a.

The following thrusts act on the first valve body 71 configured in the foregoing manner: a thrust in the direction of opening the first valve body 71 attributed to the pressure in the main port 82, and a thrust in the direction of closing the first valve body 71 attributed to the pressure in the first pressure chamber 78a, i.e., the pressure in the control pressure chamber 42, and the biasing force of the first spring 74.

When the thrust in the direction of opening the first valve body 71 exceeds the thrust in the direction of closing the first valve body 71, the first valve body 71 is opened, and the main port 82 and the control pressure chamber 42 communicate with each other via the recess 22g, a gap between the first valve portion 71c and the first seat portion 88a, the first communication hole 71d, the first pressure chamber 78a, the second valve body through hole 72c, the third pressure chamber 78c, the control pressure chamber communication hole 23f, and the lead-in hole 41. These passages that enable communication between the main port 82 and the control pressure chamber 42 serve as a main port communication passage. Note that the main port communication passage is not limited to being composed of these passages, and may be configured in any manner as long as it enables communication between the main port 82 and the control pressure chamber 42.

On the other hand, when the thrust in the direction of opening the first valve body 71 falls below the thrust in the direction of closing the first valve body 71, the first valve body 71 is closed, and communication between the main port 82 and the control pressure chamber 42 is blocked. Thus, the first valve body 71 permits only the flow of working oil from the main port 82 to the control pressure chamber 42.

The second valve body 72 also has a second communication hole 72d that enables communication between the sub port 83 and the second valve body through hole 72c when the second valve portion 72e is separated from the second seat portion 88b.

The following thrusts act on the second valve body 72 configured in the foregoing manner: a thrust in the direction of opening the second valve body 72 attributed to the pressure in the sub port 83 acting on the second valve body 72 via the sub port communication hole 23d, and a thrust in the direction of closing the second valve body 72 attributed to the pressure in the third pressure chamber 78c, i.e., the pressure in the control pressure chamber 42, and the biasing force of the second spring 75.

When the thrust in the direction of opening the second valve body 72 exceeds the thrust in the direction of closing the second valve body 72, the second valve body 72 is opened, and the sub port 83 and the control pressure chamber 42 communicate with each other via the sleeve communication holes 12b, the sub port communication hole 23d, the second pressure chamber 78b, a gap between the second valve portion 72e and the second seat portion 88b, the second communication hole 72d, the second valve body through hole 72c, the third pressure chamber 78c, the control pressure chamber communication hole 23f, and the lead-in hole 41. These passages that enable communication between the sub port 83 and the control pressure chamber 42 serve as a sub port communication passage. Note that the sub port communication passage is not limited to being composed of these passages, and may be configured in any manner as long as it enables communication between the sub port 83 and the control pressure chamber 42. For example, the second communication hole 72d may be a groove-like passage provided on an outer circumferential surface of the second valve body 72.

On the other hand, when the thrust in the direction of opening the second valve body 72 falls below the thrust in the direction of closing the second valve body 72, the second valve body 72 is closed, and communication between the sub port 83 and the control pressure chamber 42 is blocked. Thus, the second valve body 72 permits only the flow of working oil from the sub port 83 to the control pressure chamber 42, and prevents the outflow of working oil from the main port 82 and the control pressure chamber 42 to the sub port 83.

Although some passages are shared by the foregoing main port communication passage and sub port communication passage, no limitation is intended in this regard. The main port communication passage and the sub port communication passage may be provided independently of each other inside the valve body 22.

Inside the control pressure chamber 42, there is a section that faces the other end surface 22f of the main valve 22. A main return spring 24 is provided in a compressed state between the main valve 22 and the solenoid unit 60 in this section.

A biasing force of the main return spring 24 acts in the direction of closing the main valve 22. The pressure in the main port 82 acts on a first valve-opening pressure receiving surface S1 that is equivalent to a cross-section of the second seat portion 13b of the main valve 22, thereby acting in a direction of opening the main valve 22. The pressure in the sub port 83 acts on a second valve-opening pressure receiving surface S2 that is equivalent to a cross-section of the step portion 22h of the main valve 22, thereby acting in the direction of opening the main valve 22. The pressure inside the control pressure chamber 42 acts on a valve-closing pressure receiving surface S3 that is equivalent to a cross-section of the slide portion 22c, thereby acting in the direction of closing the main valve 22.

Therefore, the main valve 22 is displaced in the direction of opening the main valve 22 when a net force obtained from a thrust attributed to the pressure in the main port 82 acting on the first valve-opening pressure receiving surface S1 and from a thrust attributed to the pressure in the sub port 83 acting on the second valve-opening pressure receiving surface S2 exceeds a net force obtained from a thrust attributed to the pressure inside the control pressure chamber 42 acting on the valve-closing pressure receiving surface S3 and from the biasing force of the main return spring 24. On the other hand, the main valve 22 is displaced in the direction of closing the main valve 22 when the former falls below the latter.

The main valve 22 also includes a pilot pressure control valve 25 that controls the pressure inside the control pressure chamber 42 by adjusting the state of communication between the control pressure chamber 42 and the sub port 83.

The pilot pressure control valve 25 includes the hollow cylindrical pressure compensation sleeve 26 provided with a sub seat 26d, and the columnar sub valve 27. One end of the sub valve 27 has a sub poppet valve 27a that can be seated on the sub seat 26d.

The pressure compensation sleeve 26 has a slide portion 26a that is slidably inserted in the sleeve slide hole 73a of the plug 73, a flange 26b that faces the control pressure chamber 42 and is larger in outer diameter than the slide portion 26a, and a sleeve through hole 26c that penetrates the flange 26b and the slide portion 26a in the axial direction. The sub seat 26d is provided at an open end of the sleeve through hole 26c that opens to the flange 26b. Therefore, the sleeve slide hole 73a and the control pressure chamber 42 communicate with each other via the sub seat 26d and the sleeve through hole 26c.

A pressure compensation spring 28 composed of a plurality of disc springs is interposed between the flange 26b and the plug 73. The pressure compensation sleeve 26 is biased by the pressure compensation spring 28 in a direction away from the main valve 22.

When the sub poppet valve 27a and the sub seat 26d are in contact with each other, communication between the control pressure chamber 42 and the sleeve slide hole 73a is blocked. On the other hand, when the sub poppet valve 27a is separated from the sub seat 26d, a gap is created between the sub poppet valve 27a and the sub seat 26d. Accordingly, the control pressure chamber 42 and the sleeve slide hole 73a communicate with each other. As a result, working oil inside the control pressure chamber 42 is discharged to the sub port 83 through the sleeve slide hole 73a, the plug communication hole 73b, the discharge passage 23e, and the sub port communication hole 23d. Although working oil is directed to the control pressure chamber 42 through the main port communication passage, as the lead-in hole 41 limits the inflow of working oil to the control pressure chamber 42, the pressure inside the control pressure chamber 42 decreases in consequence. The pressure inside the control pressure chamber 42 is thus controlled by the pilot pressure control valve 25.

The size of the gap between the sub poppet valve 27a and the sub seat 26d is adjusted by changing a position of the sub valve 27 in the axial direction relative to the pressure compensation sleeve 26. As the solenoid unit 60 controls the position of the sub valve 27 in the axial direction, the solenoid unit 60 controls the size of this gap.

The solenoid unit 60 includes a coil 62 that generates a magnetic attractive force when current is supplied thereto, a cylindrical solenoid tube 14 with a bottom, and a joint member 16 that joins the solenoid tube 14 and the sleeve 12 together. The coil 62 is provided around an outer circumference of the solenoid tube 14.

A cylindrical plunger 33, a columnar retainer 34, and a sub return spring 35 are provided inside the solenoid tube 14. The plunger 33 is attracted by the magnetic attractive force generated by the coil 62, and the sub valve 27 is fixed to a shaft center of the plunger 33. The retainer 34 is movable in the axial direction. The sub return spring 35 is interposed in a compressed state between the plunger 33 and the retainer 34. The sub return spring 35 biases the plunger 33 in a direction of seating the sub poppet valve 27a, which is provided on a tip of the sub valve 27, on the sub seat 26d.

The plunger 33 has a plurality of through holes 33a that penetrate the plunger 33 in the axial direction. A spring chamber 44, in which the sub return spring 35 is disposed, communicates with the control pressure chamber 42 via the through holes 33a. Therefore, the pressure inside the spring chamber 44 is equal to the pressure inside the control pressure chamber 42, and a biasing force of the sub return spring 35 and the pressure inside the spring chamber 44 act in a direction of pressing the sub poppet valve 27a toward the sub seat 26d.

An adjustment screw 36 is screwed to an end portion 14a of the solenoid tube 14 so as to penetrate the end portion 14a in the axial direction. One end of the adjustment screw 36 is in contact with the retainer 34 disposed inside the spring chamber 44. Rotation of the adjustment screw 36 changes a position of the retainer 34 in the axial direction, thereby changing the biasing force of the sub return spring 35. Thus, an initial load that is generated by the sub return spring 35 and acts on the plunger 33 can be changed by rotating the adjustment screw 36. The other end of the adjustment screw 36 projects from the solenoid tube 14, and is covered by a cover 63 attached to the solenoid tube 14.

The joint member 16 includes an insertion portion 16a that is inserted in the insertion hole 81 of the valve block 80, and a flange 16b for fixing the solenoid valve 100 to the valve block 80. The solenoid tube 14 is screwed to an inner circumferential surface of the flange 16b, and the sleeve 12 is screwed to the insertion portion 16a. As a result, the joint member 16 joins the sleeve 12 and the solenoid tube 14 together.

An O-ring 53 serving as a seal member is mounted on an outer circumference of the insertion portion 16a. The O-ring 53, which is compressed between the joint member 16 and the insertion hole 81, blocks communication between the interior of the insertion hole 81 and the outside. This can not only prevent working oil inside the insertion hole 81 from leaking to the outside, but also prevent external water, dust, and so forth from entering the interior of the insertion hole 81.

The flange 16b has a plurality of non-illustrated bolt holes through which bolts 15 are inserted. The flange 16b is fastened to the valve block 80 via the bolts 15. The solenoid valve 100 is fixed to the valve block 80 by causing the joint member 16 to be fastened to the valve block 80.

The operations of the solenoid valve 100 will now be described.

When current is not supplied to the coil 62, the plunger 33 is pressed by the biasing force of the sub return spring 35, the sub poppet valve 27a of the sub valve 27 is seated on the sub seat 26d, and the control pressure chamber 42 is in a closed state. In this state, when the pressure in the main port 82 is higher than the pressure inside the control pressure chamber 42, the first valve body 71 is opened as described above. As the pressure in the sub port 83 is sufficiently lower than the pressure in the main port 82 connected to the fluid pressure source, the pressure in the second pressure chamber 78b, which communicates with the sub port 83, becomes low. Therefore, the pressure in the second pressure chamber 78b has a small effect on the operations of the first valve body 71.

Once the first valve body 71 has been opened, working oil in the main port 82 is directed to the interior of the control pressure chamber 42, and the pressure inside the control pressure chamber 42 becomes equal to the pressure in the main port 82. As a result, the pressure equal to the pressure in the main port 82 acts on the other end surface 22f of the main valve 22. That is, the pressure equal to the pressure in the main port 82 acts on the valve-closing pressure receiving surface S3.

At this time, working oil is directed from the main port 82 to the third pressure chamber 78c that biases the second valve body 72 in the direction of closing the second valve body 72, and the pressure inside the third pressure chamber 78c becomes equal to the pressure in the main port 82. As the pressure in the sub port 83 is sufficiently lower than the pressure in the main port 82, the pressure in the second pressure chamber 78b, which communicates with the sub port 83, becomes low. Accordingly, the second valve body 72 is maintained in a state where the second valve portion 72e is seated on the second seat portion 88b.

Here, the valve-closing pressure receiving surface S3 on which the pressure inside the control pressure chamber 42 acts is larger in area than the first valve-opening pressure receiving surface S1 on which the pressure in the main port 82 acts. Furthermore, the pressure in the sub port 83 is sufficiently lower than the pressure in the main port 82. Therefore, the net force obtained from the thrust attributed to the pressure inside the control pressure chamber 42 acting on the valve-closing pressure receiving surface S3 and from the biasing force of the main return spring 24 exceeds the net force obtained from the thrust attributed to the pressure in the main port 82 acting on the first valve-opening pressure receiving surface S1 and from the thrust attributed to the pressure in the sub port 83 acting on the second valve-opening pressure receiving surface S2. Consequently, the main valve 22 is biased in a direction of closing the seat 13. Thus, when current is not flowing through the coil 62, the flow of working oil from the main port 82 to the sub port 83 is blocked.

On the other hand, when current is supplied to the coil 62, the thrust generated by the solenoid unit 60 causes the plunger 33 to overcome the biasing force of the sub return spring 35, and the plunger 33 is attracted toward the coil 62. As the sub valve 27 is displaced together with the plunger 33, the sub poppet valve 27a is separated from the sub seat 26d, and a gap is created between the sub poppet valve 27a and the sub seat 26d. Via this gap, working oil inside the control pressure chamber 42 passes through the sleeve through hole 26c, the plug communication hole 73b, the discharge passage 23e, the sub port communication hole 23d, and the sleeve communication holes 12b, and then is discharged to the sub port 83.

As the lead-in hole 41 limits the inflow of working oil from the main port 82 to the control pressure chamber 42, the pressure inside the control pressure chamber 42 decreases due to communication between the control pressure chamber 42 and the sub port 83. The main valve 22 is displaced in a direction of opening the seat 13 until the net force obtained from the thrust attributed to the pressure inside the control pressure chamber 42 acting on the valve-closing pressure receiving surface S3 and from the biasing force of the main return spring 24 comes into balance with the net force obtained from the thrust attributed to the pressure in the main port 82 acting on the first valve-opening pressure receiving surface S1 and from the thrust attributed to the pressure in the sub port 83 acting on the second valve-opening pressure receiving surface S2. As a result, working oil flows from the main port 82 to the sub port 83 through a space between the through holes 22d and the first seat portion 13a, a space between the poppet valve 22b and the second seat portion 13b, and the sleeve communication holes 12b.

An increase in the current supplied to the coil 62 causes the sub poppet valve 27a to be further separated from the sub seat 26d. As a result, an amount of working oil discharged from the control pressure chamber 42 to the sub port 83 increases, and the pressure inside the control pressure chamber 42 further decreases. Along with such a decrease in the pressure inside the control pressure chamber 42, the main valve 22 moves further in the direction of opening the seat 13. This leads to an increase in the exposed opening areas of the through holes 22d of the spool valve 22a created by separation from the first seat portion 13a. Consequently, a flow rate of working oil flowing from the main port 82 to the sub port 83 increases.

As described above, a flow rate of working oil flowing from the main port 82 to the sub port 83 is controlled by controlling an amount of displacement of the main valve 22 through an operation of increasing/decreasing current supplied to the coil 62.

When current is stopped from flowing through the coil 62, the thrust that attracts the plunger 33 is dissolved, and thus the plunger 33 is pressed by the biasing force of the sub return spring 35 in the direction of seating the sub poppet valve 27a on the sub seat 26d. Then, the sub poppet valve 27a of the sub valve 27 is seated on the sub seat 26d. As a result, working oil in the main port 82 is directed to the interior of the control pressure chamber 42 through the lead-in hole 41, and the pressure inside the control pressure chamber 42 increases to the point where it is equal to the pressure in the main port 82.

Once the pressure inside the control pressure chamber 42 has become equal to the pressure in the main port 82, the net force obtained from the thrust attributed to the pressure in the main port 82 acting on the first valve-opening pressure receiving surface S1 and from the thrust attributed to the pressure in the sub port 83 acting on the second valve-opening pressure receiving surface S2 falls below the net forth obtained from the thrust attributed to the pressure inside the control pressure chamber 42 acting on the valve-closing pressure receiving surface S3 and from the biasing force of the main return spring 24, as described above. Thus, the main valve 22 is biased in the direction of closing the seat 13. As a result, the main valve 22 is displaced in the direction of closing the seat 13, and the flow of working oil from the main port 82 to the sub port 83 is blocked.

A description is now given of a case in which the pressure in the sub port 83 exceeds the pressure in the main port 82.

After the supply of working oil to the actuator is stopped by stopping the flow of current through the coil 62, if the pressure inside the actuator increases due to, for example, an increase in an external load acting on the actuator, the pressure in the sub port 83 that communicates with the actuator increases as well. As shown in FIG. 1, the pressure in the sub port 83 acts on the step portion 22h of the main valve 22 in the direction of opening the main valve 22. Therefore, if the pressure in the sub port 83 exceeds the pressure inside the control pressure chamber 42, the net force obtained from the thrust attributed to the pressure in the main port 82 acting on the first valve-opening pressure receiving surface S1 and from the thrust attributed to the pressure in the sub port 83 acting on the second valve-opening pressure receiving surface S2 may exceed the net forth obtained from the thrust attributed to the pressure inside the control pressure chamber 42 acting on the valve-closing pressure receiving surface S3 and from the biasing force of the main return spring 24. This could possibly open the main valve 22, and cause the outflow of working oil from the sub port 83 to the main port 82.

In the solenoid valve 100 according to the present embodiment, the occurrence of such a phenomenon can be restrained by the presence of the second valve body 72 that permits only the flow of working oil from the sub port 83 to the control pressure chamber 42.

Specifically, when the pressure in the sub port 83 exceeds the pressure in the main port 82 and the pressure inside the control pressure chamber 42, the second valve body 72 is opened as described above. Then, working oil in the sub port 83 is directed to the interior of the control pressure chamber 42, and the pressure inside the control pressure chamber 42 becomes equal to the pressure in the sub port 83.

Once the pressure inside the control pressure chamber 42 has thus become equal to the pressure in the sub port 83, a force acting in the direction of closing the main valve 22 always exceeds a force acting in the direction of opening the main valve 22, even if the pressure in the sub port 83 increases. Therefore, even if the pressure in the sub port 83 exceeds the pressure in the control pressure chamber 42, the main valve 22 is maintained in a closed state, and the outflow of working oil from the sub port 83 to the main port 82 is prevented. This restrains a displacement of the actuator caused by, for example, an increase in a load after the supply of working oil to the actuator is stopped.

The foregoing first embodiment achieves the following functions and advantageous effects.

When the pressure in the sub port 83 exceeds the pressure in the control pressure chamber 42, working oil is directed from the sub port 83 to the control pressure chamber 42 through the sub port communication passage. Thus, the pressure in the control pressure chamber 42, which biases the main valve 22 in the direction of closing the main valve 22, becomes equal to the pressure in the sub port 83. Accordingly, the main valve 22 is maintained in the closed state. This can prevent the outflow of working oil from the sub port 83 to the main port 82.

In the solenoid valve 100, the first valve body 71 and the second valve body 72 are arranged in series along their displacement direction. This enables a compact arrangement of the first valve body 71 and the second valve body 72. Thus, the solenoid valve 100 can be downsized.

### Second Embodiment

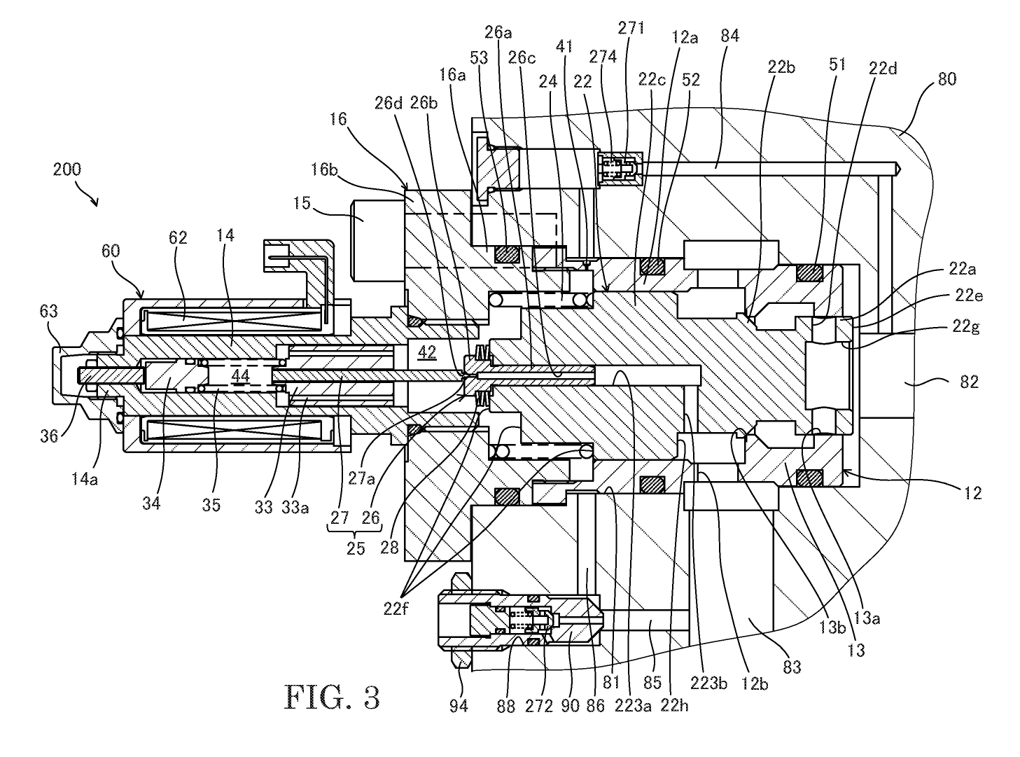

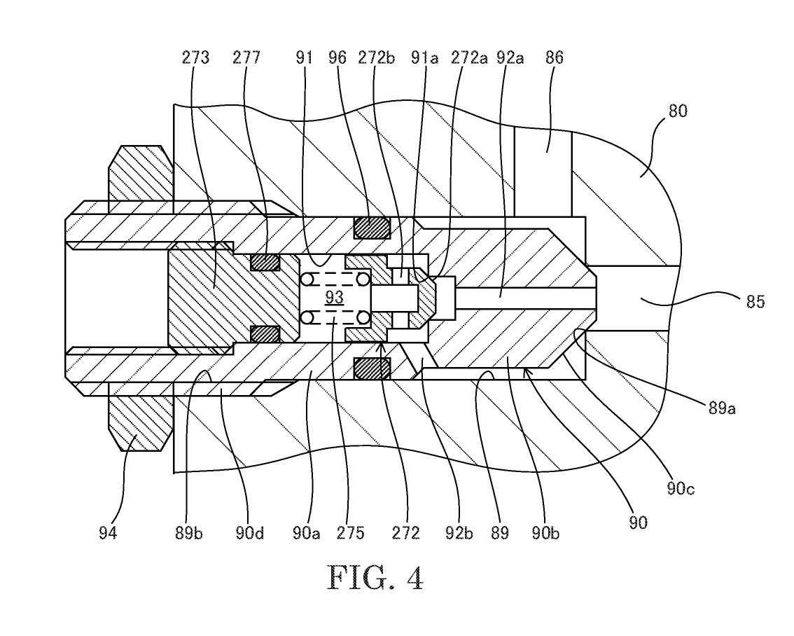

A solenoid valve 200 according to a second embodiment of the present invention will now be described with reference to FIGS. 3 and 4. In the following description, differences from the first embodiment will be focused on. Components that are similar to components according to the first embodiment will be given the same reference signs thereas, and a description thereof will be omitted.

The basic configuration of the solenoid valve 200 is similar to the basic configuration of the solenoid valve 100 according to the first embodiment. The solenoid valve 200 differs from the solenoid valve 100 in that a first valve body 271 and a second valve body 272 are both disposed in a valve block 80.

The first valve body 271 of the solenoid valve 200 is disposed in a main port communication hole 84 provided in the valve block 80. The main port communication hole 84 opens to a main port 82 at one end, opens to a side surface of an insertion hole 81 at the other end, and communicates with a control pressure chamber 42 via a lead-in hole 41 that is provided in a sleeve 12 and functions as an orifice.

The following thrusts act on the first valve body 271: a thrust in a direction of opening the first valve body 271 attributed to the pressure in the main port 82, and a thrust in a direction of closing the first valve body 271 attributed to the pressure in the control pressure chamber 42 and a biasing force of a spring 274.

When the thrust in the direction of opening the first valve body 271 exceeds the thrust in the direction of closing the first valve body 271, the first valve body 271 is opened, and the main port 82 and the control pressure chamber 42 communicate with each other via the main port communication hole 84 and the lead-in hole 41. These passages that enable communication between the main port 82 and the control pressure chamber 42 serve as a main port communication passage. Note that the main port communication passage is not limited to being composed of these passages, and may be configured in any manner as long as it enables communication between the main port 82 and the control pressure chamber 42. For example, the main port communication hole 84 and the lead-in hole 41 may be provided inside a main valve 22, rather than in the valve block 80. In this case, the first valve body 271 is disposed inside the main valve 22 as well.

On the other hand, when the thrust in the direction of opening the first valve body 271 falls below the thrust in the direction of closing the first valve body 271, the first valve body 271 is closed, and communication between the main port 82 and the control pressure chamber 42 is blocked. Thus, the first valve body 271 permits only the flow of working oil from the main port 82 to the control pressure chamber 42.

As shown in FIG. 4, the second valve body 272 is disposed inside a release valve 90 that blocks or enables communication between a first sub port communication hole 85 and a second sub port communication hole 86 that are provided in the valve block 80.

A non-penetrating release valve insertion hole 89 that allows the cylindrical release valve 90 to be fixedly inserted therein is provided in the valve block 80 so as to extend parallel to the insertion hole 81. The first sub port communication hole 85 opens to a bottom surface of the release valve insertion hole 89 at one end, and is connected to a sub port 83 at the other end. The second sub port communication hole 86 opens to a side surface of the release valve insertion hole 89 at one end, opens to a side surface of the insertion hole 81 at the other end, and communicates with the control pressure chamber 42 via the lead-in hole 41.

The release valve 90 includes a slide portion 90a, a male thread portion 90d, a small-diameter portion 90b, and a valve portion 90c. The slide portion 90a is slidably supported by the release valve insertion hole 89. The male thread portion 90d is screwed to a female thread portion 89b provided at an open end of the release valve insertion hole 89. The small-diameter portion 90b is located at the side of the release valve 90 opposite to the male thread portion 90d, and is smaller in outer diameter than the slide portion 90a. The valve portion 90c is located at a tip of the small-diameter portion 90b, and can be seated on a seat 89a that is provided at an open end of the first sub port communication hole 85 and forms a circular truncated cone.

A locknut 94 is screwed to the male thread portion 90d of the release valve 90. The release valve 90 is fixed inside the release valve insertion hole 89 by fastening the locknut 94. Normally, the release valve 90 is fixed in a state where the valve portion 90c is seated on the seat 89a, that is, a state where communication between the first sub port communication hole 85 and the second sub port communication hole 86 is blocked. The release valve 90 is opened by loosening the locknut 94 and rotating the release valve 90. Once the release valve 90 has been opened, the first sub port communication hole 85 and the second sub port communication hole 86 can communicate with each other without involvement of the second valve body 272.

The release valve 90 also has a non-penetrating slide hole 91, a first communication hole 92a, and a second communication hole 92b. The slide hole 91 opens to an end surface of the release valve 90 near the male thread portion 90d, and extends along a shaft center of the release valve 90. The first communication hole 92a opens to a bottom surface of the slide hole 91 at one end, and opens to an end surface of the release valve 90 near the small-diameter portion 90b at the other end. The second communication hole 92b opens to a side surface of the slide hole 91 at one end, and opens to an outer circumferential surface of the small-diameter portion 90b at the other end.

The second valve body 272 is slidably housed in the slide hole 91. A plug 273 is screwed to an open end of the slide hole 91. A spring chamber 93 serving as a pressure chamber is defined between the second valve body 272 and the plug 273. A spring 275 that biases the second valve body 272 in a direction of closing the second valve body 272 is installed in a compressed state inside the spring chamber 93.

The second valve body 272 has a valve portion 272a and a communication hole 272b. The valve portion 272a can be seated on a seat 91a that is provided at an open end of the first communication hole 92a and forms a circular truncated cone. The communication hole 272b always enables communication between the spring chamber 93 and the second communication hole 92b. As the second communication hole 92b opens to the outer circumferential surface of the small-diameter portion 90b at one end, it communicates with the control pressure chamber 42 via a gap between the small-diameter portion 90b and the release valve insertion hole 89, the second sub port communication hole 86, and the lead-in hole 41. Therefore, the spring chamber 93 always communicates with the control pressure chamber 42. As a result, the pressure in the spring chamber 93 is equal to the pressure in the control pressure chamber 42.

The following thrusts act on the second valve body 272 configured in the foregoing manner: a thrust in a direction of opening the second valve body 272 attributed to the pressure in the sub port 83 acting on the second valve body 272 via the first sub port communication hole 85 and the first communication hole 92a, and a thrust in the direction of closing the second valve body 272 attributed to the pressure in the spring chamber 93, i.e., the pressure in the control pressure chamber 42, and a biasing force of the spring 275.

When the thrust in the direction of opening the second valve body 272 exceeds the thrust in the direction of closing the second valve body 272, the second valve body 272 is opened, and the sub port 83 and the control pressure chamber 42 communicate with each other via the first sub port communication hole 85, the first communication hole 92a, a gap between the valve portion 272a and the seat 91a, the second communication hole 92b, a gap between the small-diameter portion 90b and the release valve insertion hole 89, the second sub port communication hole 86, and the lead-in hole 41. These passages that enable communication between the sub port 83 and the control pressure chamber 42 serve as a sub port communication passage. Note that the sub port communication passage is not limited to being composed of these passages, and may be configured in any manner as long as it enables communication between the sub port 83 and the control pressure chamber 42 via the release valve 90.

On the other hand, when the thrust in the direction of opening the second valve body 272 falls below the thrust in the direction of closing the second valve body 272, the second valve body 272 is closed, and communication between the sub port 83 and the control pressure chamber 42 is blocked. Thus, the second valve body 272 permits only the flow of working oil from the sub port 83 to the control pressure chamber 42, and prevents the outflow of working oil from the main port 82 and the control pressure chamber 42 to the sub port 83.

An O-ring 96 is mounted on an outer circumference of the slide portion 90a of the release valve 90. The O-ring 96, which is compressed between the release valve insertion hole 89 and the slide portion 90a, blocks communication between the interior of the release valve insertion hole 89 and the outside. An O-ring 277 is mounted on an outer circumference of the plug 273. The O-ring 277, which is compressed between the slide hole 91 and the plug 273, blocks communication between the interior of the slide hole 91 and the outside. This can not only prevent working oil inside the release valve insertion hole 89 and the slide hole 91 from leaking to the outside, but also prevent external water, dust, and so forth from entering the interior of the release valve insertion hole 89 and the interior of the slide hole 91.

The operations of the solenoid valve 200 will now be described.

When current is not supplied to a coil 62, a plunger 33 is pressed by a biasing force of a sub return spring 35, a sub poppet valve 27a of a sub valve 27 is seated on a sub seat 26d, and the control pressure chamber 42 is in a closed state. In this state, when the pressure in the main port 82 is higher than the pressure inside the control pressure chamber 42, the first valve body 271 is opened as described above.

When the first valve body 271 is opened, working oil in the main port 82 is directed to the interior of the control pressure chamber 42, and the pressure inside the control pressure chamber 42 becomes equal to the pressure in the main port 82. As a result, the pressure equal to the pressure in the main port 82 acts on the other end surface 22f of the main valve 22. That is, the pressure equal to the pressure in the main port 82 acts on a valve-closing pressure receiving surface S3.

At this time, working oil is directed from the main port 82, through the control pressure chamber 42, to the spring chamber 93 that biases the second valve body 272 in the direction of closing the second valve body 272, and the pressure inside the spring chamber 93 becomes equal to the pressure in the main port 82. As the pressure in the sub port 83 is sufficiently lower than the pressure in the main port 82, the pressure acting in the direction of opening the second valve body 272 via the first communication hole 92a becomes low. Accordingly, the second valve body 272 is maintained in a state where the valve portion 272a is seated on the seat 91a.

Note that a description of other operations of the solenoid valve 200 will be omitted, because they are the same as the operations of the solenoid valve 100 according to the first embodiment except that, when the main valve 22 is opened, working oil inside the control pressure chamber 42 is discharged to the sub port 83 through a first discharge passage 223a and a second discharge passage 223b provided inside the main valve 22.

A description is now given of a case in which the pressure in the sub port 83 exceeds the pressure in the main port 82.

When the pressure in the sub port 83 exceeds the pressure in the main port 82 and the pressure inside the control pressure chamber 42, the second valve body 272 is opened as described above. Then, working oil in the sub port 83 is directed to the interior of the control pressure chamber 42, and the pressure inside the control pressure chamber 42 becomes equal to the pressure in the sub port 83.

Once the pressure inside the control pressure chamber 42 has thus become equal to the pressure in the sub port 83, a force acting in a direction of closing the main valve 22 always exceeds a force acting in a direction of opening the main valve 22, even if the pressure in the sub port 83 increases. Therefore, even if the pressure in the sub port 83 exceeds the pressure in the control pressure chamber 42, the main valve 22 is maintained in a closed state. This prevents the outflow of working oil from the sub port 83 to the main port 82. As a result, displacement of an actuator caused by, for example, an increase in a load is restrained after the supply of working oil to the actuator is stopped.

The following describes how the release valve 90 is maneuvered.

The release valve 90 is opened manually, for example, when working oil is to be supplied to the actuator without the flow of current through the coil 62, or when the main valve 22 is not opened even though current is flowing through the coil 62 due to the failure of a solenoid unit 60. Once the release valve 90 has been opened, the control pressure chamber 42 and the sub port 83 communicate with each other, thereby causing the outflow of working oil from the control pressure chamber 42 to the sub port 83. As a result, the pressure in the control pressure chamber 42 decreases, and the main valve 22 is opened. This enables the supply of working oil to the actuator.

Specifically, the maneuver to open the release valve 90 is carried out in a state where a pump supplies working oil to the main port 82 and the main valve 22 is closed due to the pressure of working oil directed from the main port 82 to the control pressure chamber 42.

The release valve 90 is opened by loosening the locknut 94, and rotating the release valve 90 manually so as to separate the valve portion 90c from the seat 89a. Once a gap has been created between the valve portion 90c and the seat 89a, the first sub port communication hole 85 and the second sub port communication hole 86 are placed in a state where they always communicate with each other via this gap. As a result, the control pressure chamber 42 and the sub port 83 communicate with each other via the lead-in hole 41, the second sub port communication hole 86, and the first sub port communication hole 85. Working oil inside the control pressure chamber 42 is discharged to the sub port 83 through these passages. With a decrease in the pressure in the control pressure chamber 42, the pressure in the main port 82 presses and opens the main valve 22, and working oil is supplied to the actuator through the main port 82 and the sub port 83.

Thus, working oil can be supplied to the actuator by opening the release valve 90 manually, irrespective of an opening/closing operation of the second valve body 272 provided inside the release valve 90.

The foregoing second embodiment achieves the following functions and advantageous effects.

In the solenoid valve 200, both the second valve body 272 and the release valve 90 are provided in the sub port communication passage. Therefore, even if the pressure in the sub port 83 exceeds the pressure in the control pressure chamber 42, the outflow of working oil from the sub port 83 to the main port 82 can be prevented, and working oil can be supplied to the actuator without the flow of current through the coil 62.

In the solenoid valve 200, the second valve body 272 is provided inside the release valve 90. Thus, there is no need to create a passage provided with the second valve body 272 and a passage provided with the release valve 90 separately from each other. Accordingly, the solenoid valve 200 can be downsized.

The configurations, functions, and advantageous effects of the embodiments of the present invention will be collectively described below.

The solenoid valve 100 (200) controls a flow rate of working oil flowing from the main port 82 to the sub port 83, and includes: the main valve 22 configured to enable communication between the main port 82 and the sub port 83; the control pressure chamber 42 configured to bias the main valve 22 in the direction of closing the main valve 22; the main port communication passage configured to enable communication between the main port 82 and the control pressure chamber 42; the sub port communication passage configured to enable communication between the sub port 83 and the control pressure chamber 42; the first valve body 71 (271) provided in the main port communication passage, and configured to permit only the flow of working oil from the main port 82 to the control pressure chamber 42; the second valve body 72 (272) provided in the sub port communication passage, and configured to permit only the flow of working oil from the sub port 83 to the control pressure chamber 42; and the solenoid unit 60 configured to control an opening degree for communication between the control pressure chamber 42 and the sub port 83.

With this configuration, the second valve body 72 (272), which permits only the flow of working oil from the sub port 83 to the control pressure chamber 42, is provided in the sub port communication passage. Therefore, when the pressure in the sub port 83 exceeds the pressure in the control pressure chamber 42, working oil is directed from the sub port 83 to the control pressure chamber 42 through the sub port communication passage. Accordingly, the pressure in the control pressure chamber 42 that biases the main valve 22 in the direction of closing the main valve 22 becomes equal to the pressure in the sub port 83. For this reason, even if the pressure in the sub port 83 exceeds the pressure inside the control pressure chamber 42, the main valve 22 of the solenoid valve 100 (200) (the unidirectional flow control valve) is prevented from getting opened, and maintained in the closed state. This can prevent the outflow of working oil from the sub port 83 to the main port 82.

The first valve body 71 and the second valve body 72 are disposed inside the main valve 22.

The main port communication passage and the sub port communication passage are provided inside the main valve 22, and at least one of the central axis of the first valve body 71 and the central axis of the second valve body 72 coincides with the central axis of the main valve 22.

With these configurations, the passage provided with the first valve body 71 and the passage provided with the second valve body 72 are provided inside the main valve 22, and at least one of the central axes of the first valve body 71 and the second valve body 72, which are disposed inside the main valve 22, coincides with the central axis of the main valve 22. Accordingly, the passages can be processed along with processing of the main valve 22. This can reduce the manufacturing cost of the solenoid valve 100. Furthermore, the solenoid valve 100 can be downsized compared with a case in which the passages are provided in a portion other than the main valve 22.

The first valve body 71 and the second valve body 72 are displaced in the same displacement direction, and are arranged in series along the displacement direction.

With this configuration, the first valve body 71 that permits only the flow of working oil from the main port 82 to the control pressure chamber 42, and the second valve body 72 that permits only the flow of working oil from the sub port 83 to the control pressure chamber 42, are arranged in series along the displacement direction. This enables a compact arrangement of the first valve body 71 and the second valve body 72. Thus, the solenoid valve 100 can be downsized.

A release valve 90 is also included. The release valve 90 is provided in the sub port communication passage, and configured to open the sub port communication passage when the release valve 90 is opened manually.

With this configuration, both the second valve body 272 and the release valve 90 are provided in the sub port communication passage. Therefore, even if the pressure in the sub port 83 exceeds the pressure in the control pressure chamber 42, the outflow of working oil from the sub port 83 to the main port 82 can be prevented, and working oil can be supplied to the actuator without the flow of current through the coil 62. Furthermore, working oil can be supplied to the actuator even when the main valve 22 is not opened despite the flow of current through the coil 62 due to the failure of the solenoid unit 60. Moreover, as the second valve body 272 and the release valve 90 are provided in the same passage, the solenoid valve 200 can be downsized.

The second valve body 272 is provided inside the release valve 90, and the sub port communication passage is opened when the release valve 90 is opened, irrespective of an opening/closing operation of the second valve body 272.

With this configuration, the second valve body 272 is provided inside the release valve 90. Thus, there is no need to create a passage provided with the second valve body 272 and a passage provided with the release valve 90 separately from each other. Accordingly, the solenoid valve 200 can be downsized.

The solenoid valve 100 (200) further includes the pressure chamber 78c (93) configured to communicate with the control pressure chamber 42, and bias the second valve body 72 (272) in the direction of closing the second valve body 72 (272). Working oil is directed from the main port 82 to the pressure chamber 78c (93) when the first valve body 71 (271) is opened.

With this configuration, when the first valve body 71 (271) is opened, working oil is directed from the main port 82 to the pressure chamber 78c (93) that biases the second valve body 72 (272) in the direction of closing the second valve body 72 (272), and the second valve body 72 (272) is reliably closed. This can prevent the outflow of working oil from the main port 82 to the sub port 83 through the second valve body 72 (272).

Embodiments of the present invention were described above, but the above embodiments are merely examples of applications of the present invention, and the technical scope of the present invention is not limited to the specific constitutions of the above embodiments.

This application claims priority based on Japanese Patent Application No. 2015-175880 filed with the Japan Patent Office on Sep. 7, 2015, the entire contents of which are incorporated into this specification by reference.

1. A unidirectional flow control valve capable of controlling a flow rate of a working fluid flowing from a main port to a sub port, the unidirectional flow control valve comprising:
a main valve configured to enable communication between the main port and the sub port;
a control pressure chamber configured to bias the main valve in a direction of closing the main valve;
a main port communication passage configured to enable communication between the main port and the control pressure chamber;
a sub port communication passage configured to enable communication between the sub port and the control pressure chamber;
a first valve body provided in the main port communication passage, the first valve body being configured to permit only a flow of the working fluid from the main port to the control pressure chamber;
a second valve body provided in the sub port communication passage, the second valve body being configured to permit only a flow of the working fluid from the sub port to the control pressure chamber; and
a solenoid unit configured to control an opening degree for communication between the control pressure chamber and the sub port.

2. The unidirectional flow control valve according to claim 1,
wherein
the first valve body and the second valve body are disposed inside the main valve.

3. The unidirectional flow control valve according to claim 2,
wherein
the main port communication passage and the sub port communication passage are provided inside the main valve, and
at least one of a central axis of the first valve body and a central axis of the second valve body coincides with a central axis of the main valve.

4. The unidirectional flow control valve according to claim 1,
wherein
the first valve body and the second valve body are displaced in a same displacement direction, the first valve body and the second valve body being arranged in series along the displacement direction.

5. The unidirectional flow control valve according to claim 1, further comprising
a release valve provided in the sub port communication passage, the release valve being configured to open the sub port communication passage when the release valve is opened manually.

6. The unidirectional flow control valve according to claim 5,
wherein
the second valve body is provided inside the release valve, and
the sub port communication passage is opened when the release valve is opened, irrespective of an opening/closing operation of the second valve body.

7. The unidirectional flow control valve according to claim 1, further comprising
a pressure chamber configured to communicate with the control pressure chamber, the pressure chamber being configured to bias the second valve body in a direction of closing the second valve body,
wherein
the working fluid is directed from the main port to the pressure chamber when the first valve body is opened.
